(19) United States
(12) Patent Application Publication
(10) Pub. No.: US 2021/0036491 A1
(43) Pub. Date: Feb. 4, 2021

(54) SPARK PLUG

(71) Applicant: NGK SPARK PLUG CO., LTD., Nagoya-shi, Aichi (JP)

(72) Inventor: Yusuke KAWASHIMA, Nagoya-shi, Aichi (JP)

(73) Assignee: NGK SPARK PLUG CO., LTD., Nagoya-shi, Aichi (JP)

(21) Appl. No.: 16/640,133

(22) PCT Filed: Jul. 16, 2018
(86) PCT No.: PCT/JP2018/026627

§ 371 Date: Feb. 19, 2020

(30) Foreign Application Priority Data
Oct. 11, 2017 (JP) 2017-197403
Mar. 1, 2018 (JP) 2018-036213

(51) Int. Cl. H01T 13/16; H01T 13/36

(52) U.S. Cl. CPC H01T 13/16; H01T 13/36

(57) ABSTRACT

A spark plug that allows a heat transfer member to be fixed to an insulator in a simple manner. The spark plug includes: a tubular insulator extending in an axial line direction from a front side to a rear side; and a tubular metal shell fixed to an outer circumference of the insulator and having an external thread formed on a part of an outer circumferential surface thereof, wherein the insulator has a groove formed on a portion, of an outer circumferential surface thereof, that overlaps the external thread of the metal shell in the axial line direction, a heat transfer member mounted in the groove is in contact with an inner circumferential surface of the metal shell, and a portion of the heat transfer member is disposed in the groove of the insulator.

### TECHNICAL FIELD

The present invention relates to a spark plug and particularly relates to a spark plug having a heat transfer member fixed to the outer circumference of an insulator.

### BACKGROUND ART

A spark plug in which a tubular metal shell having an external thread that is formed thereon and that is to be coupled to an internal combustion engine holds an insulator, has been known. In the spark plug disclosed in Patent Document 1, an insulator to which a sleeve (heat transfer member) made of a metal is brazed is held by a metal shell in a state where the outer circumferential surface of the sleeve is brought into close contact with the inner circumferential surface of the metal shell. In the technology disclosed in Patent Document 1, the heat of the insulator heated by combustion gas transfers through the sleeve to the metal shell due to heat conduction, and thus a heat rating is determined by the position of the sleeve, the width of the sleeve, etc.

### PRIOR ART DOCUMENT

### Patent Document

Patent Document 1: U.S. Patent Application Publication No. 2011/0227472

### SUMMARY OF THE INVENTION

### Problem to be Solved by the Invention

In the above conventional technology, various parameters, such as wettability and reactivity between the insulator and a brazing material for joining the sleeve (heat transfer member) to the insulator and stress generated in the insulator due to the difference in coefficient of linear expansion between the sleeve and the insulator, have to be controlled, and such control is complicated.

The present invention has been made to solve the above-described problem, and an object of the present invention is to provide a spark plug that allows a heat transfer member to be fixed to an insulator in a simple manner.

### Means for Solving the Problem

In order to attain the above object, a spark plug of the present invention includes: a tubular insulator extending in an axial line direction from a front side to a rear side; and a tubular metal shell fixed to an outer circumference of the insulator and having an external thread formed on a part of an outer circumferential surface thereof, wherein the insulator has a groove formed on a portion, of an outer circumferential surface thereof, that overlaps the external thread of the metal shell in the axial line direction. A heat transfer member mounted in the groove is in contact with an inner circumferential surface of the metal shell, and a portion of the heat transfer member is disposed in the groove of the insulator.

### Advantageous Effects of the Invention

In the spark plug according to a first aspect, the heat transfer member is mounted in the groove formed on the outer circumferential surface of the insulator. The outer circumferential surface of the heat transfer member is in contact with the inner circumferential surface of the metal shell, and a portion of the heat transfer member is disposed in the groove. Thus, the heat transfer member can be fixed to the insulator in a simpler manner.

In the spark plug according to a second aspect, a plurality of the grooves are formed so as to be spaced apart from each other in the axial line direction. The heat transfer member disposed in each of the grooves transfers the heat of the insulator to the metal shell. Thus, in addition to the advantageous effect of the first aspect, a heat radiation property can be improved.

In the spark plug according to a third aspect, the distance from a slope that is a part of the inner circumferential surface of the metal shell to the axial line decreases toward the front side. The slope faces a portion, of the insulator, where the groove is formed, and the heat transfer member disposed in the groove is in contact with the slope. Thus, the heat transfer member can be barely moved toward the front side of the groove. Since the heat transfer member can easily be brought into contact with the rear side of the groove, heat can easily be conducted between the heat transfer member and the insulator in addition to the advantageous effect of the first or second aspect.

In the spark plug according to a fourth aspect, a protrusion portion of the insulator is located at the rear side in the axial line direction with respect to the groove and projects radially outward. A ledge portion of the metal shell has a rear end surface opposed to a front end surface of the protrusion portion. A seal member is interposed between the ledge portion and the protrusion portion and is in contact with the rear end surface of the ledge portion and the front end surface of the protrusion portion over entire circumferences thereof. Accordingly, in addition to the advantageous effect of any one of the first to third aspects, airtightness can be ensured between the insulator and the metal shell by the seal member.

In the spark plug according to a fifth aspect, the groove is formed over an entire circumference of the outer circumferential surface of the insulator, and the heat transfer member is mounted over an entire circumference of the groove. Accordingly, in addition to the advantageous effect of any one of the first to fourth aspects, a heat transfer area that contributes to heat transfer from the insulator to the heat transfer member can be ensured.

In the spark plug according to a sixth aspect, the heat transfer member is in contact with the inner circumferential surface of the metal shell over an entire circumference thereof. Thus, in addition to the advantageous effect of the fifth aspect, thermal conductivity from the heat transfer member to the metal shell can be improved.

In the spark plug according to a seventh aspect, the portion, of the heat transfer member, that is disposed in the groove is in contact with either one of a rearward facing surface and a frontward facing surface of the groove of the insulator and is separated from the other of the rearward facing surface and the frontward facing surface of the groove. Thermal conductivity from the insulator to the heat transfer member can be ensured by the one surface of the groove with which the heat transfer member is in contact. In addition, since the heat transfer member is separated from the other surface of the groove, stress in the axial line direction generated in the insulator due to the difference between the coefficient of linear expansion of the heat transfer member and the coefficient of linear expansion of the insulator can be inhibited. Therefore, in addition to the advantageous effect of any one of the first to sixth aspects, stress generated in the insulator due to the linear expansion difference between the heat transfer member and the insulator can be inhibited while thermal conductivity from the insulator to the heat transfer member is ensured.

In the spark plug according to an eighth aspect, the portion, of the heat transfer member, that is disposed in the groove is separated from a bottom surface of the groove. Accordingly, stress in the radial direction generated in the insulator due to the difference between the coefficient of linear expansion of the heat transfer member and the coefficient of linear expansion of the insulator can be inhibited. Therefore, in addition to the advantageous effect of any one of the first to seventh aspects, stress generated in the insulator due to the linear expansion difference between the heat transfer member and the insulator can be inhibited.

### BRIEF DESCRIPTION OF THE DRAWINGS

FIG. 1: Half cross-sectional view of a spark plug according to a first embodiment of the present invention.

FIG. 2: Exploded perspective view of an insulator and a heat transfer member.

FIG. 3: Exploded perspective view of an insulator and heat transfer members of a spark plug according to a second embodiment.

FIG. 4: Half cross-sectional view of a spark plug according to a third embodiment.

FIG. 5: Exploded perspective view of an insulator and a heat transfer member.

FIG. 6: Half cross-sectional view of an insulator and a heat transfer member of a spark plug according to a fourth embodiment.

FIG. 7: Cross-sectional view of a spark plug according to a fifth embodiment.

FIG. 8: Cross-sectional view of a spark plug according to a sixth embodiment.

FIG. 9: Cross-sectional view of a spark plug according to a seventh embodiment.

### MODES FOR CARRYING OUT THE INVENTION

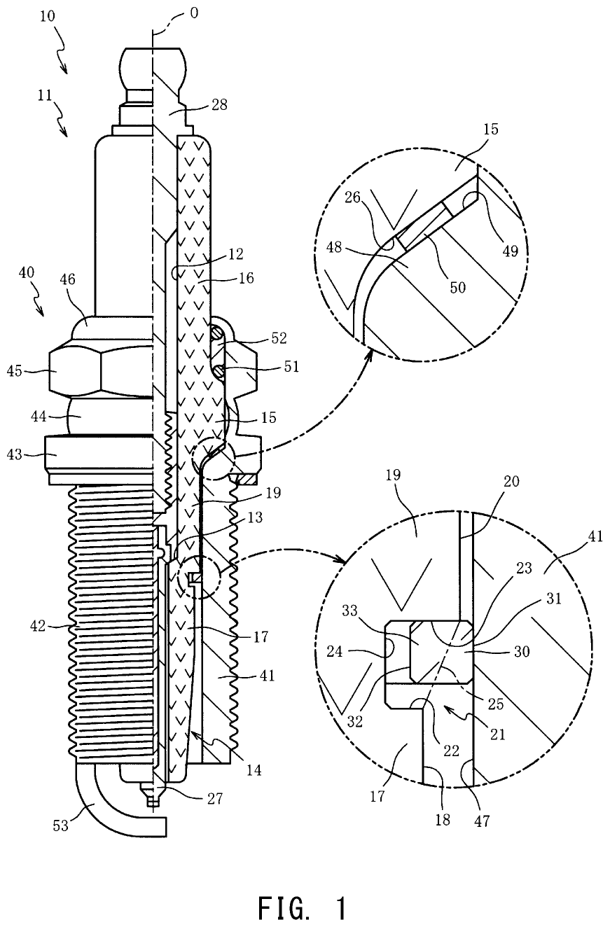

Hereinafter, preferred embodiments of the present invention will be described with reference to the accompanying drawings. FIG. 1 is a half cross-sectional view of a spark plug 10 according to a first embodiment of the present invention with an axial line O thereof as a boundary. In FIG. 1, the lower side in the drawing sheet is referred to as a front side of the spark plug 10, and the upper side in the drawing sheet is referred to as a rear side of the spark plug 10 (the same applies to the other drawings). As shown in FIG. 1, the spark plug 10 includes an insulator 11 and a metal terminal 40.

The insulator 11 is a substantially cylindrical member formed from alumina or the like that has excellent mechanical properties and insulation property at high temperature. The insulator 11 has an axial hole 12 that penetrates the insulator 11 along the axial line O. A step portion 13 that has a diameter decreasing toward the front side is formed at the front side of the axial hole 12. The insulator 11 includes a front end portion 14, a protrusion portion 15, and a rear end portion 16 that are connected to each other along the axial line O in this order from the front side. The protrusion portion 15 is a portion, of the insulator 11, that has a largest outer diameter.

The front end portion 14, which is adjacent to the front side of the protrusion portion 15, is a portion, of the insulator 11, that is disposed within a trunk portion 41 (described later) of the metal terminal 40. The front end portion 14 includes a first portion 17 and a second portion 19 adjacent to the rear side of the first portion 17. The diameter of an outer circumferential surface 18 of the first portion 17 is smaller than the diameter of an outer circumferential surface 20 of the second portion 19. A groove 21 is formed at the boundary between the first portion 17 and the second portion 19. In the present embodiment, the groove 21 is recessed inward in the radial direction of the insulator 11 and formed over the entire circumference of the insulator 11.

The groove 21 includes a rearward facing surface 22 that is connected to the outer circumferential surface 18 of the first portion 17, a frontward facing surface 23 that is connected to the outer circumferential surface 20 of the second portion 19, and a bottom surface 24 that is connected to the frontward facing surface 23 and the rearward facing surface 22. The outer diameter of the insulator 11 at the bottom surface 24 (the diameter of the bottom surface 24) is smaller than the outer diameter of the insulator 11 at each of the outer circumferential surfaces 18 and 20. A heat transfer member 30 is mounted in the groove 21.

The heat transfer member 30 is formed from a metallic material that has excellent thermal conductivity and oxidation resistance (for example, stainless steel, etc.). In the present embodiment, the heat transfer member 30 is a C-ring. At room temperature (15 to 25° C.), when no load is applied to the heat transfer member 30, the outer diameter of the heat transfer member 30 is larger than the outer diameter of the second portion 19 of the insulator 11. Similarly, at room temperature, when no load is applied to the heat transfer member 30, the inner diameter of the heat transfer member 30 is larger than the outer diameter of the insulator 11 at the bottom surface 24 of the groove 21. As a result, an inner circumferential surface 32 of the heat transfer member 30 is separated from the bottom surface 24 of the groove 21.

A center electrode 27 is a rod-shaped electrode that is inserted in the front side of the axial hole 12 and held by the insulator 11 along the axial line O. The center electrode 27 is engaged with the step portion 13 of the insulator 11 and projects at a front end thereof from the insulator 11. The center electrode 27 is obtained by embedding, in an electrode base material, a core material having excellent thermal conductivity. The electrode base material is formed from an alloy containing Ni as a main component or a metallic material made of Ni, and the core material is formed from copper or an alloy containing copper as a main component. A metal terminal 28 is a rod-shaped member to which a high-voltage cable (not shown) is to be connected, and is formed from a metallic material that has electrical conductivity (for example, low-carbon steel, etc.). The metal terminal 28 is electrically connected to the center electrode 27 within the axial hole 12.

The metal terminal 40 is a substantially cylindrical member formed from a metallic material that has electrical conductivity (for example, low-carbon steel, etc.). The metal terminal 40 includes the trunk portion 41 that surrounds the front end portion 14 of the insulator 11, a seat portion 43 that is connected to the rear side of the trunk portion 41, a compression portion 44 that is connected to the rear side of the seat portion 43, a tool engagement portion 45 that is connected to the rear side of the compression portion 44, and a bent portion 46 that is connected to the rear side of the tool engagement portion 45.

The trunk portion 41 has an external thread 42 that is formed on the outer circumference thereof and that is to be screwed into a thread hole of an internal combustion engine (not shown). In a cross-section of the trunk portion 41 taken along a plane perpendicular to the axial line O, the shape of an inner circumferential surface 47 of the trunk portion 41 is a circle centered at the axial line O. The diameter of the inner circumferential surface 47 of the trunk portion 41 is set so as to be uniform over the overall length in the axial line O direction of the trunk portion 41. The inner circumferential surface 47 of the trunk portion 41 is in contact with an outer circumferential surface 31 of the heat transfer member 30, which is mounted in the groove 21 of the insulator 11.

The seat portion 43 is a portion for closing the gap between the thread hole of the internal combustion engine (not shown) and the external thread 42, and is formed with an outer diameter larger than that of the trunk portion 41. The seat portion 43 surrounds the boundary between the front end portion 14 and the protrusion portion 15. The seat portion 43 has a ledge portion 48 formed so as to be located at the front side in the axial line O direction of the protrusion portion 15 of the insulator 11. A rear end surface 49 of the ledge portion 48 and a front end surface 26 of the protrusion portion 15 each have a diameter decreasing toward the front side.

A seal member 50 is interposed between the ledge portion 48 and the protrusion portion 15. The seal member 50 is an annular plate member that is formed from a metallic material such as a soft steel plate softer than the metallic material that forms the metal terminal 40. The seal member 50 is in contact with the rear end surface 49 of the ledge portion 48 and the front end surface 26 of the protrusion portion 15 over the entire circumferences thereof.

When the metal terminal 40 is assembled to the insulator 11, the compression portion 44 is compressed in the axial line O direction and generates elastic force to compress the protrusion portion 15 in the axial line O direction. The compression portion 44 surrounds the protrusion portion 15. The tool engagement portion 45 is a portion with which a tool such as a wrench is brought into engagement when the external thread 42 is fastened to the thread hole of the internal combustion engine (not shown). The tool engagement portion 45 surrounds a rear side portion of the protrusion portion 15 and a front side portion of the rear end portion 16 of the insulator 11. The bent portion 46 is bent radially inward and located at the rear side with respect to the protrusion portion 15.

A pair of ring members 51 and a filler 52 such as talc are disposed radially inward of the tool engagement portion 45 and the bent portion 46, frontward of the bent portion 46, and rearward of the protrusion portion 15. The filler 52 is located between the ring members 51. A portion, of the metal terminal 40, from the bent portion 46 to the ledge portion 48 applies a load that presses the insulator 11 in the axial line O direction, to the protrusion portion 15 via the filler 52. As a result, the metal terminal 40 is fixed to the outer circumference of the insulator 11. The seal member 50 and the filler 52 are compressed in the axial line O direction, and thus airtightness can be ensured. In addition, a portion of the seat portion 43 at the rear side with respect to the ledge portion 48 and a front side portion of the tool engagement portion 45 are in contact with the outer circumference of the protrusion portion 15 of the insulator 11. Accordingly, the position in the radial direction of the insulator 11 is restricted.

A ground electrode 53 is a rod-shaped member that is made of a metal (for example, a nickel-based alloy) and that is joined to the metal terminal 40. The ground electrode 53 has a front end portion opposed to the center electrode 27 with a gap (spark gap) therebetween. In the present embodiment, the ground electrode 53 is bent.

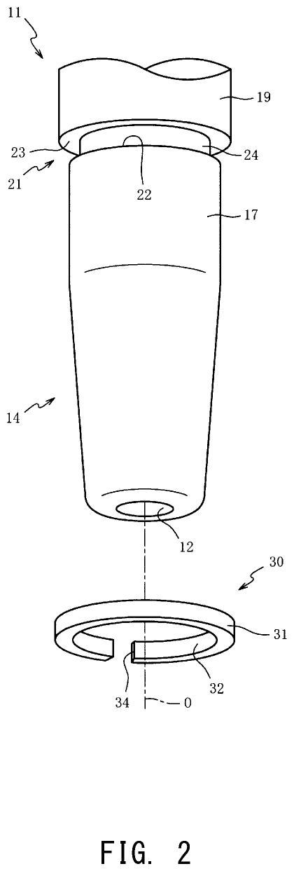

FIG. 2 is an exploded perspective view of the insulator 11 and the heat transfer member 30. In FIG. 2, the rear side of the insulator 11 is not shown. The heat transfer member 30 is formed in a C-shape by a cut 34 being formed therein. Thus, the heat transfer member 30 can be elastically deformed by widening the cut 34. When no load is applied to the heat transfer member 30, the inner diameter of the heat transfer member 30 is smaller than the outer diameter of the second portion 19 having the rearward facing surface 22 of the groove 21 of the insulator 11. However, when the insulator 11 is inserted and a load is applied to the heat transfer member 30, the cut 34 widens and the heat transfer member 30 becomes elastically deformed, so that the first portion 17 of the insulator 11 can be inserted into the heat transfer member 30. When the heat transfer member 30 is mounted into the groove 21, the load is eliminated and the heat transfer member 30 returns to the original shape. Therefore, the workability for mounting the heat transfer member 30 into the groove 21 can be improved by the cut 34 formed in the heat transfer member 30.

At room temperature, the thickness in the axial line O direction of the heat transfer member 30 is slightly smaller than the interval in the axial line O direction between the rearward facing surface 22 and the frontward facing surface 23 of the groove 21. In addition, the end face in the axial line O direction of the heat transfer member 30 perpendicularly intersects the outer circumferential surface 31. The rearward facing surface 22 and the frontward facing surface 23 of the groove 21 are also perpendicular to the axial line O. As a result, in a state where the outer circumferential surface 31 of the heat transfer member 30 is in contact with the trunk portion 41 of the metal terminal 40, when a portion 33 disposed inward of a boundary 25 of the groove 21 that connects the outer circumferential surface 18 of the first portion 17 and the outer circumferential surface 20 of the second portion 19 of the insulator 11 (in the groove 21) is brought into contact with either one of the frontward facing surface 23 and the rearward facing surface 22, the portion 33 is separated from the other of the frontward facing surface 23 and the rearward facing surface 22.

The spark plug 10 is produced, for example, by the following method. First, the center electrode 27 is inserted into the axial hole 12 of the insulator 11 and placed such that the front end of the center electrode 27 is exposed from the axial hole 12 to the outside. Next, the metal terminal 28 is fixed to the rear end of the insulator 11 with conduction ensured between the metal terminal 28 and the center electrode 27. Next, the heat transfer member 30 is mounted into the groove 21 of the insulator 11. The insulator 11 is inserted into the metal terminal 40 to which the ground electrode 53 is joined in advance, and the heat transfer member 30 is brought into contact with the inner circumferential surface 47 of the trunk portion 41. Due to friction generated between the outer circumferential surface 31 of the heat transfer member 30 and the inner circumferential surface 47 of the trunk portion 41 when the insulator 11 is inserted into the metal terminal 40, the heat transfer member 30 is brought into contact with the frontward facing surface 23 of the groove 21. The metal terminal 40 is assembled to the insulator 11 by bending the compression portion 44 and the bent portion 46, and then the ground electrode 53 is bent such that the front end portion of the ground electrode 53 is opposed to the center electrode 27, whereby the spark plug 10 is obtained.

The spark plug 10 is mounted to the internal combustion engine by fastening the external thread 42 of the metal terminal 40 to the thread hole of the internal combustion engine (not shown). When the internal combustion engine operates, the insulator 11 is heated. The heat of the insulator 11 is transmitted through the heat transfer member 30 to the trunk portion 41 of the metal terminal 40, and then transmitted from the external thread 42 to the internal combustion engine. The inner circumferential surface 32 of the heat transfer member 30 is located radially inward of the outer circumferential surface 18 of the first portion 17, to which the rearward facing surface 22 of the groove 21 is connected, and the outer circumferential surface 20 of the second portion 19, to which the frontward facing surface 23 of the groove 21 is connected. As a result, the heat transfer member 30 is held in the groove 21 by the portion 33 disposed in the groove 21. The position in the axial line O direction of the heat transfer member 30 relative to the insulator 11 is determined by the groove 21, and thus the position of the heat transfer member 30 relative to the insulator 11 can be unchanged. Accordingly, a change in the heat rating of the spark plug 10 due to vibration of the internal combustion engine on which the spark plug 10 is mounted can be prevented.

Since the heat transfer member 30 is mounted in the groove 21 and fixed to the insulator 11, various parameters, such as wettability and reactivity between a brazing material and the insulator 11 and stress generated in the insulator 11 due to the difference in coefficient of linear expansion between the heat transfer member and the insulator 11, do not have to be controlled as compared to the case of joining the heat transfer member to the insulator 11 by the brazing material. Therefore, the heat transfer member 30 can be fixed to the insulator 11 in a simple manner, and reliability of the insulator 11 to which the heat transfer member 30 is fixed can easily be ensured.

When the external thread 42 of the metal terminal 40 is fastened to the thread hole of the internal combustion engine (not shown), the external thread 42 (trunk portion 41) is stretched in the axial line O direction, and thus axial tension is generated therein. The position of the metal terminal 40 relative to the axial line O direction is merely restricted due to the friction between the trunk portion 41 and the heat transfer member 30, and the heat transfer member 30 is not integrated with the trunk portion 41. Thus, even when the trunk portion 41 stretches in the axial line O direction due to the fastening of the external thread 42, the heat transfer member 30 applies almost no force to the insulator 11 in the axial line O direction. Therefore, breakage of the insulator 11 due to the fastening of the external thread 42 can be prevented.

When no load is applied to the heat transfer member 30, the outer diameter of the heat transfer member 30 is slightly larger than the inner diameter of the trunk portion 41 of the metal terminal 40. Thus, when the insulator 11 having the heat transfer member 30 mounted in the groove 21 is inserted into the metal terminal 40 and the outer circumferential surface 31 of the heat transfer member 30 is brought into contact with the inner circumferential surface 47 of the trunk portion 41, the heat transfer member 30 becomes elastically deformed and the space of the cut 34 becomes narrower. The heat transfer member 30 and the trunk portion 41 can be brought into close contact with each other by the restoring force of the heat transfer member 30 compressed in the radial direction. Accordingly, thermal conductivity from the heat transfer member 30 to the metal terminal 40 can be ensured.

The entirety of the outer circumferential surface 31 of the heat transfer member 30, excluding the cut 34, is in contact with the trunk portion 41 of the metal terminal 40, and thus a heat transfer area can be ensured. Thus, the thermal conductivity from the heat transfer member 30 to the metal terminal 40 can be improved.

The heat rating of the spark plug 10 is determined by the position of the groove 21 in the axial line O direction of the insulator 11, the size and the coefficient of thermal conductivity of the heat transfer member 30, etc. As a result, metal terminals 40 that are different from each other in the shape of the inner circumferential surface 47 of the trunk portion 41 do not have to be prepared for respective heat ratings, and thus the number of reserve components for the metal terminal 40 can be reduced.

In the insulator 11, since the outer diameter of the first portion 17 at the front side with respect to the groove 21 is smaller than the outer diameter of the second portion 19 at the rear side with respect to the groove 21, an interval can be ensured between the inner circumferential surface 47 of the trunk portion 41 and the outer circumferential surface 18 of the first portion 17. As a result, a decrease in insulation resistance caused by adhesion of carbon, contained in combustion gas that has entered between the inner circumferential surface 47 of the trunk portion 41 and the outer circumferential surface 18 of the first portion 17, to the outer circumferential surface 18 of the first portion 17, can be inhibited. Thus, anti-fouling characteristics can be ensured. Meanwhile, in the insulator 11, since the outer diameter of the second portion 19 at the rear side with respect to the groove 21 is larger than the outer diameter of the first portion 17 at the front side with respect to the groove 21 and the interval between the outer circumferential surface 20 of the second portion 19 and the inner circumferential surface 47 of the trunk portion 41 is narrow, the heat radiation property of the insulator 11 can be improved by heat transfer from the second portion 19 to the trunk portion 41.

Since the cut 34 is formed in the heat transfer member 30, airtightness cannot be ensured between the insulator 11 and the metal terminal 40 by the heat transfer member 30. Therefore, in the spark plug 10, the seal member 50 is disposed at the rear side with respect to the groove 21 in which the heat transfer member 30 is mounted. Since the seal member 50 is in contact with the rear end surface 49 of the ledge portion 48 of the metal terminal 40 and the front end surface 26 of the protrusion portion 15 of the insulator 11 over the entire circumferences thereof, airtightness can be ensured between the insulator 11 and the metal terminal 40.

Although the outer circumferential surface 31 of the heat transfer member 30 is in contact with the metal terminal 40, since there is a gap between the inner circumferential surface 32 of the heat transfer member 30 and the bottom surface 24 of the groove 21, the heat transfer member 30 cannot fix the insulator 11 to the metal terminal 40. However, the inner surfaces of the seat portion 43 and the tool engagement portion 45 of the metal terminal 40 are in contact with the outer circumference of the protrusion portion 15 of the insulator 11, and thus the position in the radial direction of the protrusion portion 15 relative to the metal terminal 40 is restricted. Furthermore, the metal terminal 40 holds the rear end portion 16 of the insulator 11 via the ring members 51 and the filler 52, and thus the insulator 11 can be prevented from being unstable with respect to the axial line O of the metal terminal 40.

When the portion 33, which is disposed in the groove 21, is brought into contact with either one of the rearward facing surface 22 and the frontward facing surface 23 of the groove 21, the heat transfer member 30 is separated from the other of the rearward facing surface 22 and the frontward facing surface 23. Thermal conductivity from the insulator 11 to the heat transfer member 30 can be ensured by the one surface with which the heat transfer member 30 is in contact. Since the heat transfer member 30 is in contact with the metal terminal 40, thermal conductivity from the heat transfer member 30 to the metal terminal 40 is ensured. As a result, a heat radiation property of the insulator 11 can be ensured, and thus pre-ignition can be prevented.

Moreover, at least at room temperature, the other surface of the groove 21 and the heat transfer member 30 are separated from each other, and thus stress in the axial line O direction generated in the insulator 11 can be inhibited even when the heat transfer member 30 expands in the axial line O direction due to the difference between the coefficient of linear expansion of the heat transfer member 30 and the coefficient of linear expansion of the insulator 11. As a result, breakage of the insulator 11 due to the linear expansion difference between the heat transfer member 30 and the insulator 11 can be prevented.

The portion 33, of the heat transfer member 30, which is disposed in the groove 21, is separated from the bottom surface 24 of the groove 21 at least at room temperature. Accordingly, even when the heat transfer member 30 expands in the radial direction due to the difference between the coefficient of linear expansion of the heat transfer member 30 and the coefficient of linear expansion of the insulator 11, stress in the radial direction generated in the insulator 11 can be inhibited. In addition, since the heat transfer member 30 becomes elastically deformed due to the cut 34, expansion of the heat transfer member 30 in the radial direction is buffered. Therefore, stress generated in the insulator 11 due to the linear expansion difference between the heat transfer member 30 and the insulator 11 can be inhibited, so that breakage of the insulator 11 can be prevented.

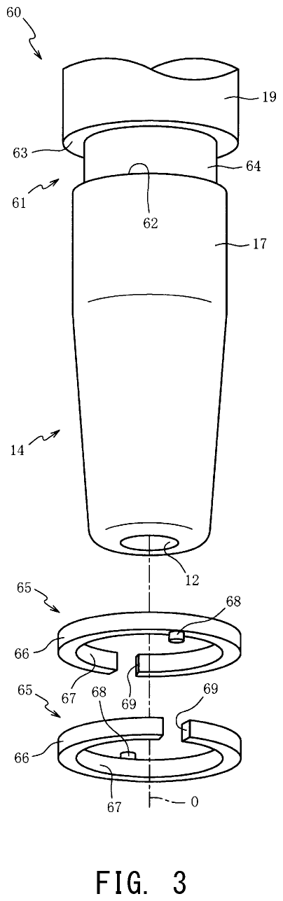

Next, a second embodiment will be described with reference to FIG. 3. In the first embodiment, the case where the one heat transfer member 30 is mounted in the groove 21 of the insulator 11 has been described. Meanwhile, in the second embodiment, the case where a plurality of heat transfer members 65 are mounted in a groove 61 of an insulator 60 will be described. The same components as those described in the first embodiment are designated by the same reference numerals, and the description thereof is omitted. FIG. 3 is an exploded perspective view of the insulator 60 and the heat transfer members 65 of a spark plug according to the second embodiment. In FIG. 3, a part of the front end portion 14 of the insulator 60 is shown, and the rear side of the insulator 60 is not shown. Similar to the first embodiment, the insulator 60 is held by the metal terminal 40.

As shown in FIG. 3, the groove 61 is formed on the front end portion 14 of the insulator 60 at the boundary between the first portion 17 and the second portion 19. In the present embodiment, the groove 61 is formed over the entire circumference of the insulator 60. The groove 61 includes a rearward facing surface 62 at which the first portion 17 is exposed to the groove 61, a frontward facing surface 63 at which the second portion 19 is exposed to the groove 61, and a bottom surface 64 that connects the frontward facing surface 63 and the rearward facing surface 62. In the groove 61, a plurality of (in the present embodiment, two) heat transfer members 65 are mounted so as to be stacked on each other.

The heat transfer members 65 are each formed from a metallic material that has excellent thermal conductivity and oxidation resistance (for example, stainless steel, etc.). In the present embodiment, the heat transfer members 65 are C-rings. At room temperature, when no load is applied to the heat transfer members 65, the outer diameters of the heat transfer members 65 are each larger than the outer diameter of the second portion 19 of the insulator 60. Similarly, at room temperature, when no load is applied to the heat transfer members 65, the inner diameters of the heat transfer members 65 are each larger than the outer diameter of the insulator 60 at the bottom surface 64 of the groove 61. As a result, inner circumferential surfaces 67 of the heat transfer members 65 are separated from the bottom surface 64 of the groove 61.

A cut 69 is formed in each of the heat transfer members 65, and a projection 68 that is narrower than the width of the cut 69 is provided at the side opposite to the cut 69 across the axial line O. Since the cuts 69 are formed, the workability for mounting the heat transfer members 65 into the groove 61 can be improved. The projections 68 project in the axial line O direction from end faces in the axial line O direction of the heat transfer members 65. The lengths in the axial line O direction of the projections 68 are each shorter than the thickness of the heat transfer member 65. The two heat transfer members 65 are disposed such that the projections 68 are placed in the cuts 69, so that the projections 68 are brought into engagement with the cuts 69. Thus, rotation of the two heat transfer members 65 is prevented such that the relative positions of the two heat transfer members 65 are not changed.

The total thickness in the axial line O direction of the two stacked heat transfer members 65 is slightly smaller than the interval in the axial line O direction between the rearward facing surface 62 and the frontward facing surface 63 of the groove 61. As a result, when the heat transfer member 65 is brought into contact with either one of the frontward facing surface 63 and the rearward facing surface 62, the heat transfer member 65 is separated from the other of the frontward facing surface 63 and the rearward facing surface 62. In addition, outer circumferential surfaces 66 of the heat transfer members 65 are in contact with the inner circumferential surface 47 of the trunk portion 41 of the metal terminal 40 (see FIG. 1). Although the cut 69 is formed in each of the heat transfer members 65, since the two heat transfer members 65 are arranged such that the positions of the cuts 69 do not overlap, the outer circumferential surfaces 66 of the heat transfer members 65 are in contact with the inner circumferential surface 47 of the metal terminal 40 over the entire circumference thereof. A decrease in the circumferential lengths of the heat transfer members 65 due to the cuts 69 can be prevented, and the heat transfer area can be made wide. Thus, thermal conductivity from the heat transfer members 65 to the metal terminal 40 can be improved.

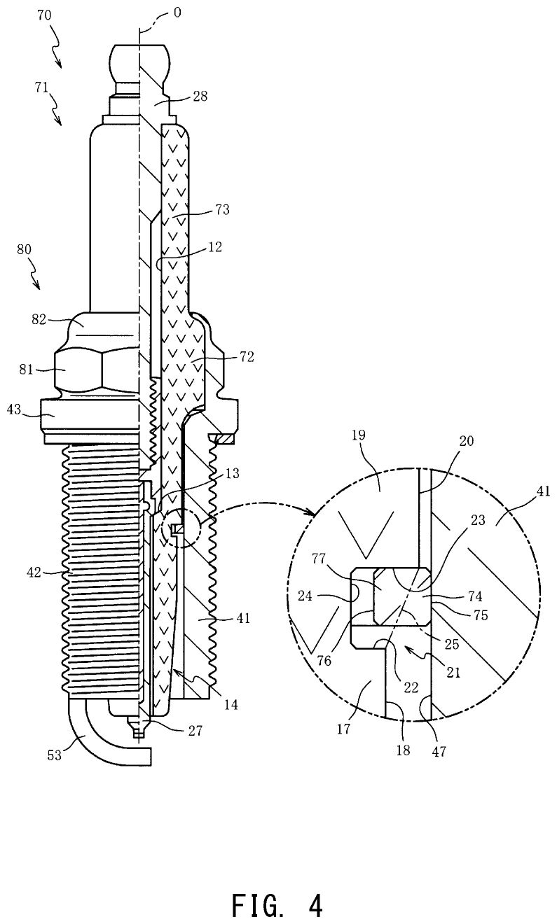

Next, a third embodiment will be described with reference to FIG. 4. In each of the first embodiment and the second embodiment, the case where airtightness is ensured between the metal terminal 40 and the insulator 11 or 60 by the seal member 50 has been described. Meanwhile, in the third embodiment, the case where airtightness is ensured between a metal shell 80 and an insulator 71 by a heat transfer member 74 will be described. The same components as those described in the first embodiment are designated by the same reference numerals, and the description thereof is omitted.

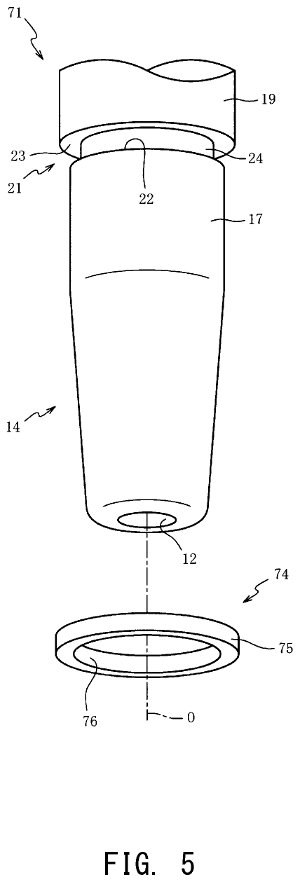

FIG. 4 is a half cross-sectional view of a spark plug 70 according to the third embodiment, and FIG. 5 is an exploded perspective view of the insulator 71 and the heat transfer member 74. In FIG. 5, a part of the front end portion 14 of the insulator 71 is shown, and the rear side of the insulator 71 is not shown. As shown in FIG. 4, the spark plug 70 includes the insulator 71 and the metal shell 80.

The insulator 71 is a substantially cylindrical member formed from alumina or the like that has excellent mechanical properties and insulation property at high temperature. The insulator 71 includes the front end portion 14, a protrusion portion 72, and a rear end portion 73 that are connected to each other along the axial line O in this order from the front side. The protrusion portion 72 is a portion, of the insulator 71, that has a largest outer diameter. The heat transfer member 74 is mounted in a groove 21 formed on the front end portion 14.

The heat transfer member 74 is an annular member formed, without any cut, from a metallic material that has excellent thermal conductivity and oxidation resistance (for example, stainless steel, etc.). At room temperature, the outer diameter of the heat transfer member 74 is larger than the outer diameter of the second portion 19 of the insulator 71. Similarly, at room temperature, the inner diameter of the heat transfer member 74 is larger than the outer diameter of the insulator 71 at the bottom surface 24 of the groove 21. As a result, an inner circumferential surface 76 of the heat transfer member 74 is separated from the bottom surface 24 of the groove 21.

To mount the heat transfer member 74 into the groove 21, the heat transfer member 74 is expanded by heating the heat transfer member 74 such that the inner diameter thereof becomes larger than the outer diameter of the first portion 17, and then the first portion 17 is inserted into the heat transfer member 74, with the front end thereof initially entering the heat transfer member 74, until the heat transfer member 74 reaches the position of the groove 21. At room temperature, the thickness in the axial line O direction of the heat transfer member 74 is slightly smaller than the interval in the axial line O direction between the rearward facing surface 22 and the frontward facing surface 23 of the groove 21. As a result, when a portion 77, of the heat transfer member 74, that is disposed inward of the boundary 25 of the groove 21 is brought into contact with either one of the frontward facing surface 23 and the rearward facing surface 22 over the entire circumferences thereof, the heat transfer member 74 is separated from the other of the frontward facing surface 23 and the rearward facing surface 22.

The metal shell 80 is a substantially cylindrical member formed from a metallic material that has electrical conductivity (for example, low-carbon steel, etc.). The metal shell 80 includes a tool engagement portion 81 that is connected to the rear side of the seat portion 43, and a contact portion 82 that is connected to the rear side of the tool engagement portion 81. An outer circumferential surface 75 of the heat transfer member 74 mounted in the groove 21 is in contact with the inner circumferential surface 47 of the trunk portion 41 over the entire circumference thereof.

The tool engagement portion 81 is a portion with which a tool such as a wrench is brought into engagement when the external thread 42 is fastened to the thread hole of the internal combustion engine (not shown). The tool engagement portion 81 surrounds the protrusion portion 72 of the insulator 71. The contact portion 82 is brought into contact with the rear end surface of the protrusion portion 72 of the insulator 71 by bending the contact portion 82 inward. The contact portion 82 of the metal shell 80 restricts the insulator 71 such that the insulator 71 does not move relative to the metal shell 80 toward the rear side.

The portion 77, of the heat transfer member 74, that is disposed in the groove 21 is in contact with either one of the frontward facing surface 23 and the rearward facing surface 22 over the entire circumference thereof. Since the outer circumferential surface 75 of the heat transfer member 74 is in contact with the inner circumferential surface 47 of the trunk portion 41 over the entire circumference thereof, airtightness can be ensured between the metal shell 80 and the insulator 71 by the heat transfer member 74.

Since the heat transfer member 74 is mounted in the groove 21, which is formed over the entire circumferences of the outer circumferential surfaces 18 and 20 of the insulator 71, over the entire circumference thereof, a heat transfer area that contributes to heat transfer from the insulator 71 to the heat transfer member 74 can be ensured. Furthermore, since the heat transfer member 74 is in contact with the inner circumferential surface 47 of the trunk portion 41 of the metal shell 80 over the entire circumference thereof, thermal conductivity from the heat transfer member 74 to the metal shell 80 can be improved.

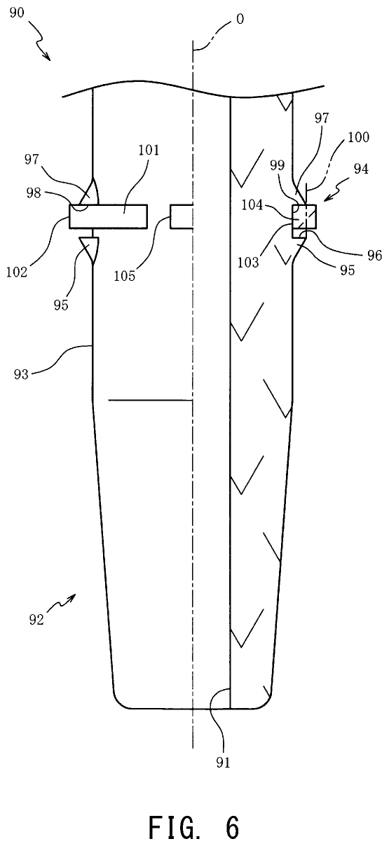

Next, a fourth embodiment will be described with reference to FIG. 6. In each of the first to third embodiments, the case where the groove 21 or 61 is recessed radially inward from the outer circumferential surfaces 18 and 20 of the insulator 11, 60, or 71 and formed over the entire circumference of the insulator 11, 60, or 71, has been described. Meanwhile, in the fourth embodiment, the case where a groove 94 is formed by projections 95 and 97 that project from parts of an outer circumferential surface 93 of an insulator 90, will be described. The same components as those described in the first embodiment are designated by the same reference numerals, and the description thereof is omitted.

FIG. 6 is a half cross-sectional view of the insulator 90 and a heat transfer member 101 with an axial line O of a spark plug according to the fourth embodiment as a boundary. In FIG. 6, a part of a front end portion 92 of the insulator 90 is shown, and the rear side of the insulator 90 and the metal terminal 40 (see FIG. 1) are not shown. Similar to the first embodiment, the insulator 90 is held by the metal terminal 40.

The insulator 90 is a substantially cylindrical member formed from alumina or the like that has excellent mechanical properties and insulation property at high temperature. The insulator 90 has an axial hole 91 that penetrates the insulator 90 along the axial line O. The insulator 90 includes the front end portion 92, a protrusion portion 15, and a rear end portion 16 that are connected to each other along the axial line O in this order from the front side. The front end portion 92 is a portion, of the insulator 90, that is disposed within the trunk portion 41 of the metal terminal 40 (see FIG. 1). In the insulator 90, the projections 95 and 97 for forming the groove 94 project radially outward from the outer circumferential surface 93 of the front end portion 92. Each of the projections 95 and 97 is provided, at two locations on the outer circumferential surface 93 opposite to each other across the axial line O, such that the projections 95 or 97 are spaced apart from each other in the axial line O direction.

A rearward facing surface 96 of the groove 94 is formed on each of the projections 95 located at the front side of the insulator 90, among the projections 95 and 97, and a frontward facing surface 98 of the groove 94 is formed on each of the projections 97 located at the rear side of the insulator 90. The rearward facing surface 96 and the frontward facing surface 98 are surfaces orthogonal to the axial line O and are located so as to be spaced apart from each other in the axial line O direction. Of the outer circumferential surface 93 of the insulator 90, a surface between the rearward facing surface 96 and the frontward facing surface 98 is a bottom surface 99 of the groove 94.

The heat transfer member 101 is a C-ring formed from a metallic material that has excellent thermal conductivity and oxidation resistance. A cut 105 is formed in the heat transfer member 101, and thus the heat transfer member 101 is elastically deformable. The width in the circumferential direction of the cut 105 is smaller than each of the widths in the circumferential direction of the projections 95 and 97. At room temperature, the thickness in the axial line O direction of the heat transfer member 101 is smaller than the distance in the axial line O direction between the rearward facing surface 96 and the frontward facing surface 98. At room temperature, when no load is applied to the heat transfer member 101, the outer diameter of the heat transfer member 101 is substantially equal to the outer diameter of the insulator 90 at the bottom surface 99 of the groove 94. The thickness in the radial direction of the heat transfer member 101 is larger than each of the heights in the radial direction of the projections 95 and 97.

An inner circumferential surface 103 of the heat transfer member 101 mounted in the groove 94 is in contact with the bottom surface 99 of the groove 94. An outer circumferential surface 102 of the heat transfer member 101 mounted in the groove 94 is located radially outward of the projections 95 and 97 and is in contact with the inner circumferential surface 47 of the trunk portion 41 of the metal terminal 40 (see FIG. 1). When a portion 104, of the heat transfer member 101, that is disposed inward of a boundary 100 of the groove 94 (in the groove 94) is brought into contact with either one of the frontward facing surface 98 and the rearward facing surface 96, the heat transfer member 101 is separated from the other of the frontward facing surface 98 and the rearward facing surface 96. The boundary 100 of the groove 94 is a cylindrical surface that passes through the tops in the radial direction of the projections 95 and 97 and that has a constant distance from the axial line O.

Although the rearward facing surface 96 and the frontward facing surface 98 of the groove 94 are formed only on parts of the outer circumferential surface 93, the insulator 90 can restrict the position in the axial line O direction of the heat transfer member 101 relative to the outer circumferential surface 93. Since the outer circumferential surface 102 of the heat transfer member 101 is in contact with the trunk portion 41 of the metal terminal 40, heat transfers from the heat transfer member 101 to the metal terminal 40 due to heat conduction. Accordingly, a change in the heat rating of the spark plug during use of the spark plug can be prevented. In addition, since the inner circumferential surface 103 of the heat transfer member 101 is in contact with the bottom surface 99 of the groove 94, heat transfers from the insulator 90 to the heat transfer member 101 due to heat conduction. Accordingly, thermal conductivity from the insulator 90 to the heat transfer member 101 can be improved.

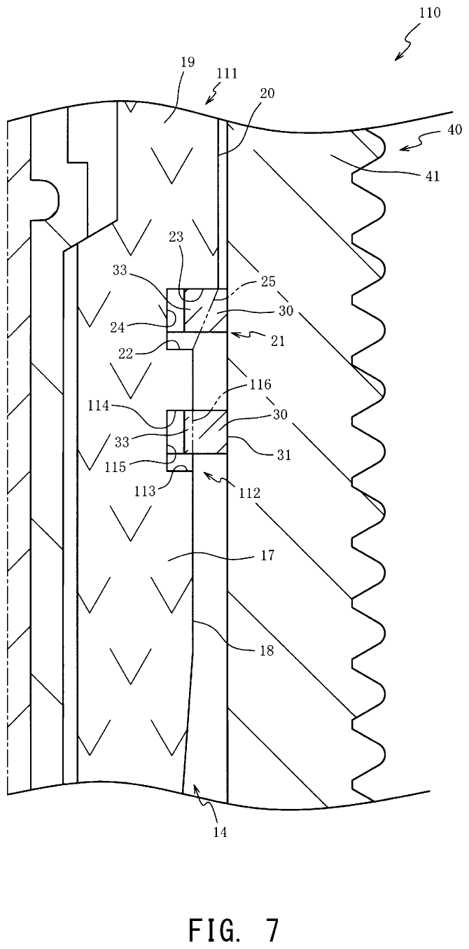

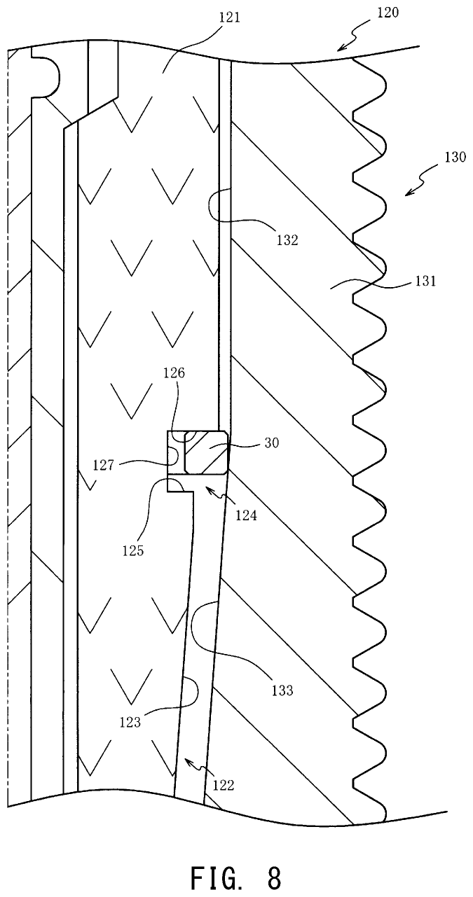

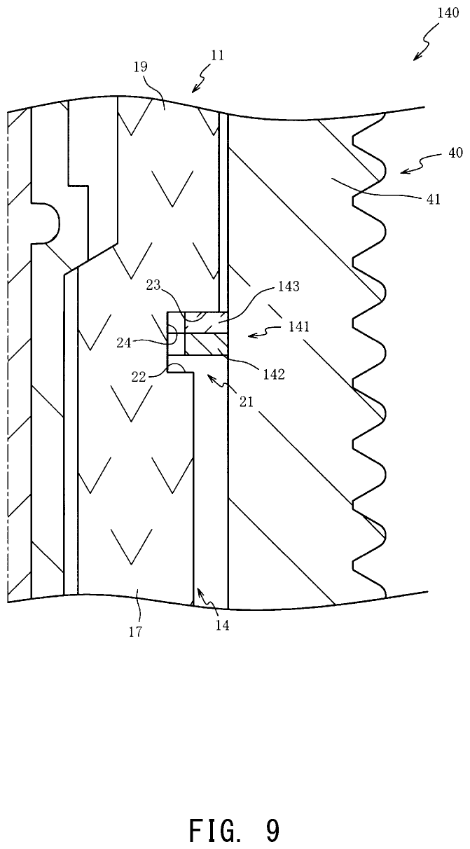

A fifth embodiment will be described with reference to FIG. 7. In each of the first to fourth embodiments, the case where the one groove 21, 61, or 94 is provided on the insulator 11, 60, 71, or 90 has been described. Meanwhile, in the fifth embodiment, the case where a heat transfer member 30 is disposed in each of a plurality of grooves 21 and 112 formed on the insulator 11, will be described. The same components as those described in the first embodiment are designated by the same reference numerals, and the description thereof is omitted. FIG. 7 is a cross-sectional view of a spark plug 110 according to the fifth embodiment. In FIG. 7, the front side and the rear side of the spark plug 110 are not shown, and one side of the spark plug 110 with an axial line O thereof as a boundary is not shown (the same applies to FIG. 8 and FIG. 9).

In an insulator 111 of the spark plug 110, the groove 112 is formed on the first portion 17 so as to be spaced apart from the groove 21 in the axial line O direction. The groove 112 is recessed inward in the radial direction of the insulator 111 and formed over the entire circumference of the insulator 111. The groove 112 includes a rearward facing surface 113 and a frontward facing surface 114 that are connected to the outer circumferential surface 18 of the first portion 17, and a bottom surface 115 that is connected to the frontward facing surface 114 and the rearward facing surface 113. The outer diameter of the insulator 111 at the bottom surface 115 (the diameter of the bottom surface 115) is smaller than the outer diameter of the insulator 111 at the outer circumferential surface 18. The heat transfer member 30 is mounted in the groove 112. At room temperature (15 to 25° C.), when no load is applied to the heat transfer member 30, the inner diameter of the heat transfer member 30 is larger than the outer diameter of the insulator 111 at the bottom surface 115 of the groove 112. Thus, the inner circumferential surface 32 of the heat transfer member 30 is separated from the bottom surface 115 of the groove 112.

At room temperature, the thickness in the axial line O direction of the heat transfer member 30 is slightly smaller than the interval in the axial line O direction between the rearward facing surface 113 and the frontward facing surface 114 of the groove 112. The rearward facing surface 113 and the frontward facing surface 114 of the groove 112 are perpendicular to the axial line O. As a result, in a state where the outer circumferential surface 31 of the heat transfer member 30 is in contact with the trunk portion 41 of the metal terminal 40, when the portion 33 disposed inward of a boundary 116 of the groove 112 that connects the outer circumferential surface 18 of the first portion 17 of the insulator 111 (in the groove 112) is brought into contact with either one of the frontward facing surface 114 and the rearward facing surface 113, the heat transfer member 30 is separated from the other of the frontward facing surface 114 and the rearward facing surface 113.

In the spark plug 110, the heat transfer members 30 mounted on the respective grooves 21 and 112 transfer the heat of the insulator 111 to the metal terminal 40, and thus a heat transfer area can be increased as compared to the case where one groove 21 is provided on the insulator 11, whereby the heat radiation property can be improved. Each of the number of grooves 21 and 112 and the number of heat transfer members 30 is not limited to two, and can be set as appropriate. The amount of heat that transfers from the insulator 111 through the heat transfer members 30 to the metal terminal 40 increases substantially in proportion to the number of heat transfer members 30 disposed in the respective grooves 21 and 112 formed on the insulator 111, that is, the heat transfer area.

A sixth embodiment will be described with reference to FIG. 8. In each of the first to fifth embodiments, the case where the inner diameter of the trunk portion 41 of the metal terminal 40 or 80 is uniform over the overall length thereof in the axial line O direction, has been described. Meanwhile, in the sixth embodiment, the case where a slope 133 whose distance to the axial line O decreases toward the front side is formed on an inner circumferential surface 132 of a trunk portion 131 of a metal shell 130, will be described. The same components as those described in the first embodiment are designated by the same reference numerals, and the description thereof is omitted. FIG. 8 is a cross-sectional view of a spark plug 120 according to the sixth embodiment.

The spark plug 120 includes an insulator 121 held by the metal shell 130. The insulator 121 includes a front end portion 122 that is disposed within the trunk portion 131, of the metal shell 130, on which an external thread 42 is formed on the outer circumference thereof. A groove 124 is formed on an outer circumferential surface 123 of the front end portion 122. The outer diameter of the front end portion 122 at the front side with respect to the groove 124 decreases toward the front side. The groove 124 is provided over the entire circumference of the front end portion 122. The groove 124 includes a rearward facing surface 125 and a frontward facing surface 126 that are connected to the outer circumferential surface 123 of the front end portion 122, and a bottom surface 127 that is connected to the frontward facing surface 126 and the rearward facing surface 125. The heat transfer member 30 is mounted in the groove 124. At room temperature (15 to 25° C.), when no load is applied to the heat transfer member 30, the inner diameter of the heat transfer member 30 is larger than the outer diameter of the insulator 121 at the bottom surface 127 of the groove 124. Thus, the inner circumferential surface 32 of the heat transfer member 30 is separated from the bottom surface 127 of the groove 124.

At least a part of the inner circumferential surface 132 of the trunk portion 131 of the metal shell 130 includes the slope 133 whose distance to the axial line O (the length of a line segment that is perpendicular to the axial line O and that connects the slope 133 and the axial line O) decreases toward the front side. The slope 133 faces a portion, of the insulator 121, on which the groove 124 is formed. In the present embodiment, the slope 133 is provided at the front side in the axial line O direction from a portion of, the inner circumferential surface 132 of the trunk portion 131, that is opposed to the frontward facing surface 126 of the groove 124. At room temperature, the thickness in the axial line O direction of the heat transfer member 30 is slightly smaller than the interval in the axial line O direction between the rearward facing surface 125 and the frontward facing surface 126 of the groove 124.

However, in a state where the outer circumferential surface 31 of the heat transfer member 30 is in contact with the slope 133 of the metal shell 130, the heat transfer member 30 cannot move in the groove 124 toward the front side unless the heat transfer member 30 is elastically compressed toward the radially inner side. Thus, in a state where the heat transfer member 30 is brought into contact with the slope 133 of the metal shell 130, when the heat transfer member 30 is brought into contact with the frontward facing surface 126, the heat transfer member 30 and the frontward facing surface 126 can be barely separated from each other even under the influence of vibration of the internal combustion engine (not shown), fluctuations of combustion pressure, or the like. As a result, the frontward facing surface 126 of the insulator 121 and the heat transfer member 30 can easily be brought into contact with each other to conduct heat from the frontward facing surface 126 to the heat transfer member 30. Thus, pre-ignition can easily be prevented.

A seventh embodiment will be described with reference to FIG. 9. In each of the first to sixth embodiments, the case where the heat transfer member 30, 65, 74, or 101 is formed from a single material has been described. Meanwhile, in the seventh embodiment, the case where a heat transfer member 141 is formed from a plurality of materials will be described. The same components as those described in the first embodiment are designated by the same reference numerals, and the description thereof is omitted. FIG. 9 is a cross-sectional view of a spark plug 140 according to the seventh embodiment.

In the spark plug 140, the heat transfer member 141 is mounted in the groove 21 of the insulator 11. In the present embodiment, the heat transfer member 141 is a C-ring formed from a clad material. The heat transfer member 141 is obtained by joining a first portion 142 and a second portion 143, which are formed from metallic materials having different properties, to each other in the thickness direction thereof (axial line O direction). The second portion 143 is disposed at the rear side with respect to the first portion 142. The first portion 142 is made of a metal containing an element such as Ni, Cr, Pt, and Co (including an alloy), and the oxidation resistance of the first portion 142 is higher than that of the second portion 143. The second portion 143 is made of a metal containing an element such as Cu, Ag, and Hf (including an alloy), and the coefficient of thermal conductivity of the second portion 143 is higher than that of the first portion 142.

Accordingly, oxidation of the second portion 143 whose temperature is less likely to be increased by combustion gas than the temperature of the first portion 142 is inhibited, and a coefficient of thermal conductivity of the second portion 143 can easily be ensured. Thus, a heat radiation property by the second portion 143 of the heat transfer member 141 can be ensured. In some cases, it is difficult to produce a heat transfer member that can achieve both oxidation resistance and a coefficient of thermal conductivity, using one member. However, since the heat transfer member 141 is divided into the first portion 142 and the second portion 143, materials that are excellent in the respective characteristics can be adopted, and thus both oxidation resistance and a coefficient of thermal conductivity of the heat transfer member can be achieved as a whole.

Although the present invention has been described based on the embodiments, the present invention is not limited to the above embodiments at all. It can be easily understood that various modifications may be made without departing from the gist of the present invention.

In the embodiments, stainless steel has been described as an example of the material of the heat transfer member 30, 65, 74, or 101, but the present invention is not necessarily limited thereto. As a matter of course, it is possible to use another metallic material such as chromium that has excellent oxidation resistance and thermal conductivity, a ceramic material such as silicon carbide, TiB₂, and ZrB₂, etc. Also, as a matter of course, it is possible to use one obtained by coating the surface of a base material such as a metal with carbon, a ceramic material, or the like, as the heat transfer member 30, 65, 74, or 101.

In the embodiments, the case where the heat transfer member 30, 65, 74, 101, or 141 has a rectangular cross-section has been described, but the present invention is not necessarily limited thereto. The cross-section of each of the heat transfer members 30, 65, 74, 101, and 141 can be set as appropriate to a shape such as a circle and a triangle.

In each of the first embodiment, the second embodiment, and the seventh embodiment, the case where the heat transfer member 30, 65, or 141 is a C-ring has been described, but the present invention is not necessarily limited thereto. As a matter of course, it is possible to form these heat transfer members as E-rings or in an annular shape. Also, it is possible to omit the projections 68 of the heat transfer members 65 described in the second embodiment.

In each of the first embodiment, the second embodiment, the fifth embodiment, the sixth embodiment, and the seventh embodiment, the case where the groove 21, 61, 112, or 124 is formed over the entire circumference of the outer circumferential surface 18, 20, or 123 of the insulator 11, 60, 111, or 121 has been described. However, the present invention is not necessarily limited thereto. For example, as a matter of course, it is possible to form a groove in a linear shape or a circular arc shape at one or a plurality of locations on the outer circumferential surface 18, 20, or 123 of the insulator 11, 60, 111, or 121. In this case, a heat transfer member having a U shape or a heat transfer member having a circular arc shape or a bow shape can be used. By inserting both legs of a heat transfer member having a U shape into the grooves, or inserting one or a plurality of heat transfer members having a circular arc shape or a bow shape into the grooves, the heat transfer members can be fixed to the insulator 11, 60, 111, or 121.

In each of the first embodiment, the second embodiment, the fifth embodiment, the sixth embodiment, and the seventh embodiment, the case where the heat transfer member 30, 65, or 141 is present within one plane has been described. However, the present invention is not necessarily limited thereto. The heat transfer member 30, 65, or 141 may be helically twisted such that the cut 34 or 69 is widened in the axial line O direction. In the case where the heat transfer member 30, 65, or 141 is helically twisted, when the heat transfer member 30, 65, or 141 mounted in the groove 21, 61, 112, or 124 is compressed in the axial line O direction by the rearward facing surface 22, 62, 113, or 125 and the frontward facing surface 23, 63, 114, or 126, the heat transfer member 30, 65, or 141 is brought into contact with the rearward facing surface 22, 62, 113, or 125 and the frontward facing surface 23, 63, 114, or 126 by the restoring force thereof.

In each of the first embodiment, the second embodiment, the fifth embodiment, the sixth embodiment, and the seventh embodiment, the case where the rearward facing surface 22, 62, 113, or 125 and the frontward facing surface 23, 63, 114, or 126 of the groove 21, 61, 112, or 124 are perpendicular to the axial line O, has been described. However, the present invention is not necessarily limited thereto. As a matter of course, it is possible to form the rearward facing surface 22, 62, 113, or 125 and the frontward facing surface 23, 63, 114, or 126 of the groove 21, 61, 112, or 124 in a helical shape having a predetermined lead angle. In this case, when a heat transfer member twisted in a helical shape is adopted and the lead angles of the rearward facing surface 22, 62, 113, or 125, the frontward facing surface 23, 63, 114, or 126, and the heat transfer member are made equal to each other, the heat transfer member mounted in the groove 21, 61, 112, or 124 can be brought into surface contact with the rearward facing surface 22, 62, 113, or 125 and the frontward facing surface 23, 63, 114, or 126 and thus the heat transfer area can be increased. Thus, such a case is preferable. Furthermore, the helical heat transfer member can be mounted by rotating the heat transfer member along the helix of the groove 21, 61, 112, or 124, and thus it is easy to mount the heat transfer member.

In each of the first embodiment, the second embodiment, the fifth embodiment, the sixth embodiment, and the seventh embodiment, the case where the ring members 51 and the filler 52 are disposed between the bent portion 46 of the metal terminal 40 and the protrusion portion 15 of the insulator 11, has been described. However, the present invention is not necessarily limited thereto. As a matter of course, it is possible to omit the ring members 51 and the filler 52 as in the third embodiment. In this case as well, airtightness can be ensured by the seal member 50.

In each of the first embodiment, the fifth embodiment, the sixth embodiment, and the seventh embodiment, the case where the cut 34 is formed in the heat transfer member 30 or 141 has been described. The size of the cut 34, that is, the length of the heat transfer member 30 or 141, can be set as appropriate. In addition, in the third embodiment, the case where the heat transfer member 74 is continuous without any cut has been described. However, the present invention is not necessarily limited thereto. As a matter of course, it is possible to divide the heat transfer member 30, 74, or 141 into a plurality of sections in the circumferential direction and mount these sections in the groove 21, 112, or 124. In the case where the heat transfer member 74 described in the third embodiment is divided into members in the circumferential direction, airtightness can be ensured, similar to the annular heat transfer member 74 having no cut, by butting the end faces in the circumferential direction of the members against each other.

In the second embodiment, the case where the seal member 50 is disposed at the rear side with respect to the heat transfer members 65 and airtightness is ensured between the insulator 60 and the metal terminal 40 by the seal member 50, has been described. However, the present invention is not necessarily limited thereto. Since the respective cuts 69 are closed by the heat transfer members 65 by stacking the two heat transfer members 65 on each other, airtightness can be ensured between the insulator 60 and the metal terminal 40 by the heat transfer members 65, similar to the third embodiment. Therefore, the seal member 50 can be omitted, or the metal shell 80 having the contact portion 82 can be fixed to the insulator 60 as in the third embodiment.

In the third embodiment, the case where the seal member 50 is omitted and the metal shell 80 having the contact portion 82 is fixed to the insulator 60, has been described. However, the present invention is not necessarily limited thereto. As a matter of course, it is possible to dispose the seal member 50 between the metal terminal 40 and the insulator 71 as in the first embodiment or the second embodiment. Accordingly, the airtightness between the metal terminal 40 and the insulator 71 can be improved.

In the fourth embodiment, the case where the projection 95 on which the rearward facing surface 96 is formed and the projection 97 on which the frontward facing surface 98 is formed are each provided at a part (two locations in the present embodiment) of a circle centered at the axial line O of the insulator 90, has been described. However, the present invention is not necessarily limited thereto. Each of the numbers of projections 95 and 97 can be set as appropriate. As a matter of course, it is possible to make the sizes or the lengths in the circumferential direction of the projections 95 and 97 different from each other. In addition, as a matter of course, it is possible to form the projections 95 and 97 in a ring shape having no cut in the circumferential direction.

By increasing the numbers or the lengths in the circumferential direction of the projections 95 and 97, or forming the projections 95 and 97 in a ring shape having no cut in the circumferential direction, the areas of the rearward facing surface 96 and the frontward facing surface 98 with which the end faces in the axial line O direction of the heat transfer member 101 are in contact can be increased. Accordingly, even when the inner circumferential surface 103 of the heat transfer member 101 is not brought into contact with the bottom surface 99 of the groove 94, a heat transfer area between the insulator 90 and the heat transfer member 101 can be ensured by the rearward facing surface 96 and the frontward facing surface 98. By separating the inner circumferential surface 103 of the heat transfer member 101 and the bottom surface 99 of the groove 94 from each other, stress in the radial direction generated in the insulator 90 due to the difference between the coefficient of linear expansion of the heat transfer member 101 and the coefficient of linear expansion of the insulator 90 can be inhibited.

In the fourth embodiment, the case where the groove 94 is formed by the projections 95 and 97 that project radially outward from the outer circumferential surface 93 of the insulator 90, has been described. However, the present invention is not necessarily limited thereto. As a matter of course, it is possible to provide a groove recessed radially inward from the outer circumferential surface 93 in addition to the projections 95 and 97. In this case, the groove may be provided at the position of the projections 95 and 97, or may be provided at a position away from the projections 95 and 97 in the circumferential direction by a predetermined distance.

In the seventh embodiment, the case where the heat transfer member 141 is formed from a clad material has been described, but the present invention is not necessarily limited thereto. As a matter of course, it is possible to form the first portion 142 and the second portion 143 by means of spraying, plating, or the like. In addition, it is possible to join the first portion 142 and the second portion 143 to each other by means of adhesion. The materials of the first portion and the second portion are not limited to metals, and, as a matter of course, it is possible to form the first portion and the second portion from other materials such as a ceramic material.

In the seventh embodiment, the heat transfer member 141 obtained by joining the first portion 142 and the second portion 143 to each other has been described, but the present invention is not necessarily limited thereto. As a matter of course, it is possible not to join the two heat transfer members 65 (a first portion and a second portion) to each other as in the second embodiment. In this case, the heat transfer member 65 at the front side is formed as a first portion having higher oxidation resistance, and the heat transfer member 65 disposed at the rear side thereof is formed as a second portion having higher thermal conductivity.

In the seventh embodiment, the case where the first portion 142 and the second portion 143 are disposed in the one groove 21 has been described, but the present invention is not necessarily limited thereto. As a matter of course, in the case where a plurality of grooves 21 and 112 are formed so as to be spaced apart from each other in the axial line O direction as in the fifth embodiment, it is possible to form a heat transfer member 30 disposed in the groove 112 at the front side, as a first portion having higher oxidation resistance, and form a heat transfer member 30 disposed in the groove 21 at the rear side, as a second portion having higher thermal conductivity. Also, in the case where three or more grooves are formed so as to be spaced apart from each other in the axial line O direction, similarly, heat transfer members disposed in (one or a plurality of) grooves formed at the front side are formed as (one or a plurality of) first portions, and heat transfer members disposed in (one or a plurality of) grooves formed at the rear side are formed as (one or a plurality of) second portions.

In the case of disposing a plurality of heat transfer members (each including a first portion and a second portion) on the insulator, it is not necessary to make the sizes (the lengths in the circumferential direction or the thicknesses in the axial line O direction) of the heat transfer members equal to each other. The sizes of the heat transfer members are set as appropriate in accordance with the outer diameter of the insulator at a portion where the groove is formed, and the width in the axial line O direction of the groove.

As a matter of course, it is possible to provide a chip containing a noble metal to the center electrode 27 or the ground electrode 53 in order to improve spark wear resistance, which is not described in the embodiments.

In the embodiments, the case where the ground electrode 53 joined to the metal terminal 40 or 80 is bent has been described, but the present invention is not necessarily limited thereto. As a matter of course, it is possible to use a linear ground electrode instead of using the bent ground electrode 53. In this case, the front side of the metal terminal 40 or 80 is extended in the axial line O direction, the linear ground electrode is joined to the metal terminal 40 or 80, and a front end portion of the ground electrode is opposed to the center electrode 27.

In the embodiments, the case where the ground electrode 53 is disposed such that the front end portion of the ground electrode 53 and the center electrode 27 are opposed to each other on the axial line O, has been described. However, the present invention is not necessarily limited thereto, and the positional relationship between the ground electrode 53 and the center electrode 27 can be set as appropriate. Regarding another positional relationship between the ground electrode 53 and the center electrode 27, for example, the ground electrode 53 is disposed such that the side surface of the center electrode 27 and the front end portion of the ground electrode 53 are opposed to each other.

In the embodiments, the case where one ground electrode 53 is joined to the metal terminal 40 or 80 has been described, but the present invention is not necessarily limited thereto. As a matter of course, it is possible to join a plurality of ground electrodes 53 to the metal terminal 40 or 80.

### DESCRIPTION OF REFERENCE NUMERALS

10, 70, 110, 120, 140: spark plug
11, 60, 71, 90, 111, 121: insulator
15: protrusion portion
18, 20, 93, 123: outer circumferential surface of insulator
21, 61, 94, 112, 124: groove
22, 62, 96, 113, 125: rearward facing surface
23, 63, 98, 114, 126: frontward facing surface
24, 64, 99, 115, 127: bottom surface
26: front end surface of protrusion portion
30, 65, 74, 101, 141: heat transfer member
33, 77: portion
40, 80, 130: metal shell
42: external thread
47, 132: inner circumferential surface of metal shell
48: ledge portion
49: rear end surface of ledge portion
50: seal member
133: slope
142: first portion of heat transfer member
143: second portion of heat transfer member
O: axial line

1. A spark plug comprising:
a tubular insulator extending in an axial line direction from a front side to a rear side; and
a tubular metal shell fixed to an outer circumference of the insulator and having an external thread formed on a part of an outer circumferential surface thereof, wherein
the insulator has a groove formed on a portion, of an outer circumferential surface thereof, that overlaps the external thread of the metal shell in the axial line direction, and
a heat transfer member mounted in the groove is in contact with an inner circumferential surface of the metal shell, and a portion of the heat transfer member is disposed in the groove of the insulator.

2. The spark plug according to claim 1, wherein
a plurality of the grooves are formed so as to be spaced apart from each other in the axial line direction, and
the heat transfer member is disposed in each of the grooves.

3. The spark plug according to claim 1, wherein
the metal shell has a slope whose distance to the axial line decreases toward the front side, on a part of the inner circumferential surface thereof,
the slope faces a portion, of the insulator, where the groove is formed, and
the heat transfer member disposed in the groove is in contact with the slope.

4. The spark plug according to claim 1, wherein
the insulator includes a protrusion portion that is located at the rear side in the axial line direction with respect to the groove and that projects radially outward,
the metal shell includes a ledge portion having a rear end surface opposed to a front end surface of the protrusion portion, and
the spark plug includes a seal member that is interposed between the ledge portion and the protrusion portion and that is in contact with the rear end surface of the ledge portion and the front end surface of the protrusion portion over entire circumferences thereof.

5. The spark plug according to claim 1, wherein
the groove is formed over an entire circumference of the outer circumferential surface of the insulator, and
the heat transfer member is mounted over an entire circumference of the groove.

6. The spark plug according to claim 5, wherein
the heat transfer member is in contact with the inner circumferential surface of the metal shell over an entire circumference thereof.

7. The spark plug according to claim 1, wherein
the portion, of the heat transfer member, that is disposed in the groove is in contact with either one of a rearward facing surface and a frontward facing surface of the groove of the insulator and is separated from the other of the rearward facing surface and the frontward facing surface of the groove.

8. The spark plug according to claim 1, wherein the portion, of the heat transfer member, that is disposed in the groove is separated from a bottom surface of the groove.
